(19) United States
(12) Patent Application Publication
(10) Pub. No.: US 2013/0180398 A1
(43) Pub. Date: Jul. 18, 2013

(54) CYLINDER DEVICE FOR A PNEUMATIC TOOL

(71) Applicant: Jerry LIN, Tainan City (TW)

(72) Inventor: Jerry LIN, Tainan City (TW)

(21) Appl. No.: 13/586,633

(22) Filed: Aug. 15, 2012

(30) Foreign Application Priority Data
Jan. 16, 2012 (TW) 101101579

(51) Int. Cl. B25F 5/00; B23P 15/00

(52) U.S. Cl. 92/169.1; 29/888.06

(57) ABSTRACT

A cylinder device is retained in a retaining space of a pneumatic tool, and includes first and second end components, a surrounding wall coupled between the first and second end components and dividing the retaining space into an annular space part and an inner space part, and a pair of main dividing members dividing the annular space part into an intake space region and an discharge space region. Compressed air introduced into the intake space region enters the inner space part via an inlet hole formed in the surrounding wall to drive rotation of a rotor disposed in the inner space part, and is advanced into the discharge space region via outlet holes formed in the surrounding wall to be expelled to the external environment.

### CROSS-REFERENCE TO RELATED APPLICATION

This application claims priority of Taiwanese Application No. 101101579, filed on Jan. 16, 2012.

### BACKGROUND OF THE INVENTION

1. Field of the Invention

The invention relates to a cylinder device, more particularly to a cylinder device for a pneumatic tool.

2. Description of the Related Art

A pneumatic tool is a device that is driven by compressed air to output work, or a device that compresses air through rotation of a rotor thereof. Air flow inside the pneumatic tool is generally guided by a conventional cylinder.

Generally, the conventional cylinder is made of metal through casting, the process of which may be costly and time-consuming. Moreover, conventional cylinders thus formed may have a relatively rough interior surface, which may reduce efficiency of the pneumatic tool.

FIGS. 1 and 2 show a conventional cylinder unit 1 for a pneumatic tool disclosed in Taiwanese Utility Model Patent No. 253264. The conventional cylinder unit 1 serves to guide air flow therein for driving rotation of a rotor 10, and includes a cylindrical base frame 11 that is made integrally of plastic, and a curved wall segment 12 that is disposed in an inner space 111 of the base frame 11 and that abuts against an inner surrounding surface of the base frame 11. The base frame 11 has a plurality of first ventilating holes 112. The wall segment 12 is formed integrally from a metal sheet through bending, and has a plurality of second ventilating holes 121 corresponding in position to the first ventilating holes 112 of the base frame 11, respectively.

Although, the inner surrounding surface of the wall segment 12 is relatively smooth, the plastic base frame 11 must be made by injection molding, and the wall segment 12 needs to be close-fitted into the base frame 11, such that the manufacturing process of the conventional cylinder unit 1 is complex, costly and time-consuming.

### SUMMARY OF THE INVENTION

Therefore, the object of the present invention is to provide a cylinder device for a pneumatic tool, which is easy to manufacture and assemble.

Accordingly, a cylinder device of the present invention is adapted for use in a pneumatic tool. The pneumatic tool includes a casing that has an inner surrounding surface defining a retaining space for retaining the cylinder device, and a rotor that is disposed in the cylinder device and that is rotatable about an axis. The cylinder device comprises:

a base frame unit including first and second end components that are disposed in the retaining space and that are spaced apart from each other along the axis; and

a cylinder body having a surrounding wall that is coupled between the first and second end components, that is eccentric with respect to the rotor, that defines an inner space part for retaining the rotor, and that cooperates with the inner surrounding surface of the casing to define an annular space part therebetween. The base frame unit further includes a pair of main dividing members that are coupled between the first and second end components, and that are disposed in the annular space part for dividing the annular space part into an intake space region and at least one discharge space region. The surrounding wall has an inlet hole that communicates fluidly the intake space region with the inner space part, and a plurality of outlet holes that communicates fluidly the at least one discharge space region with the inner space part;

wherein compressed air introduced from the external environment into the intake space region of the annular space part enters the inner space part via the inlet hole to drive rotation of the rotor, and is advanced into the discharge space region of the annular space part via the outlet holes to be expelled to the external environment.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view of a pneumatic tool with a conventional cylinder disclosed in Taiwanese Utility Model Patent No. 253264;

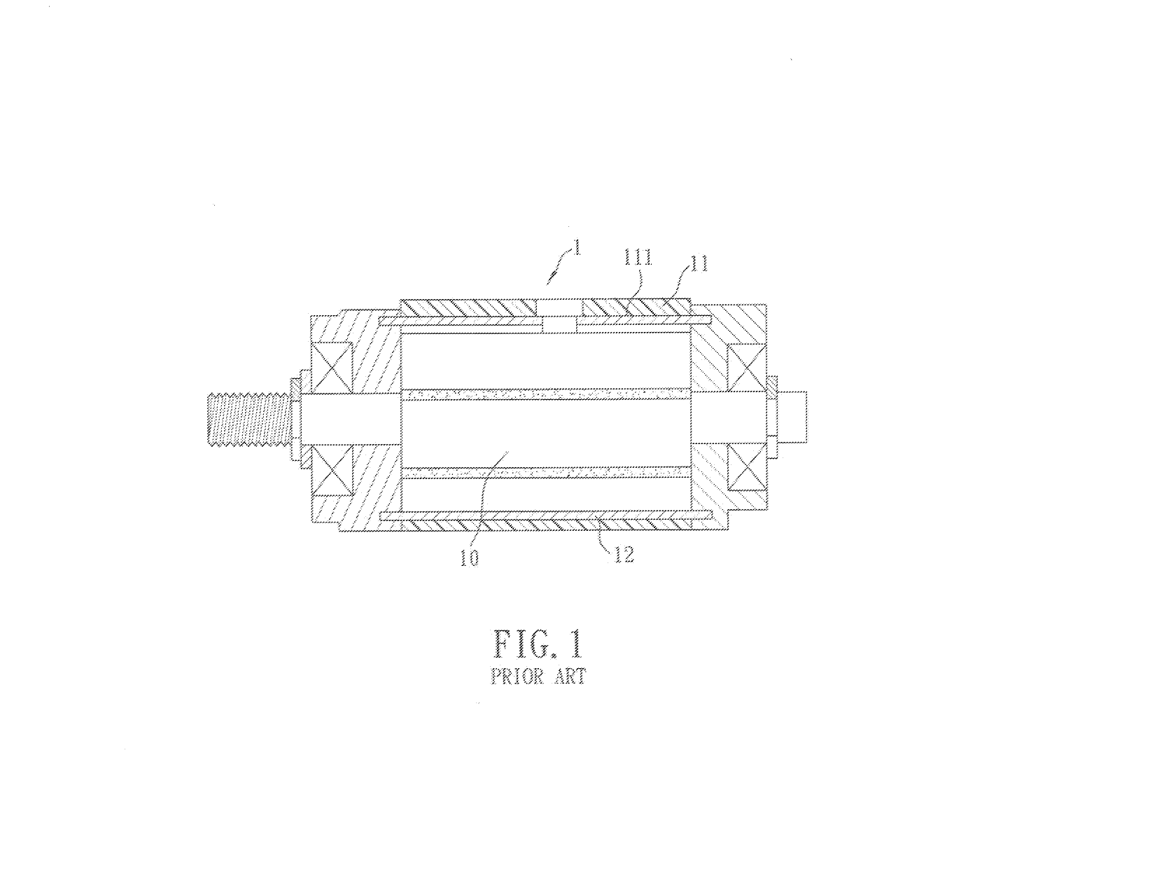

FIG. 2 is an exploded perspective view of the conventional cylinder;

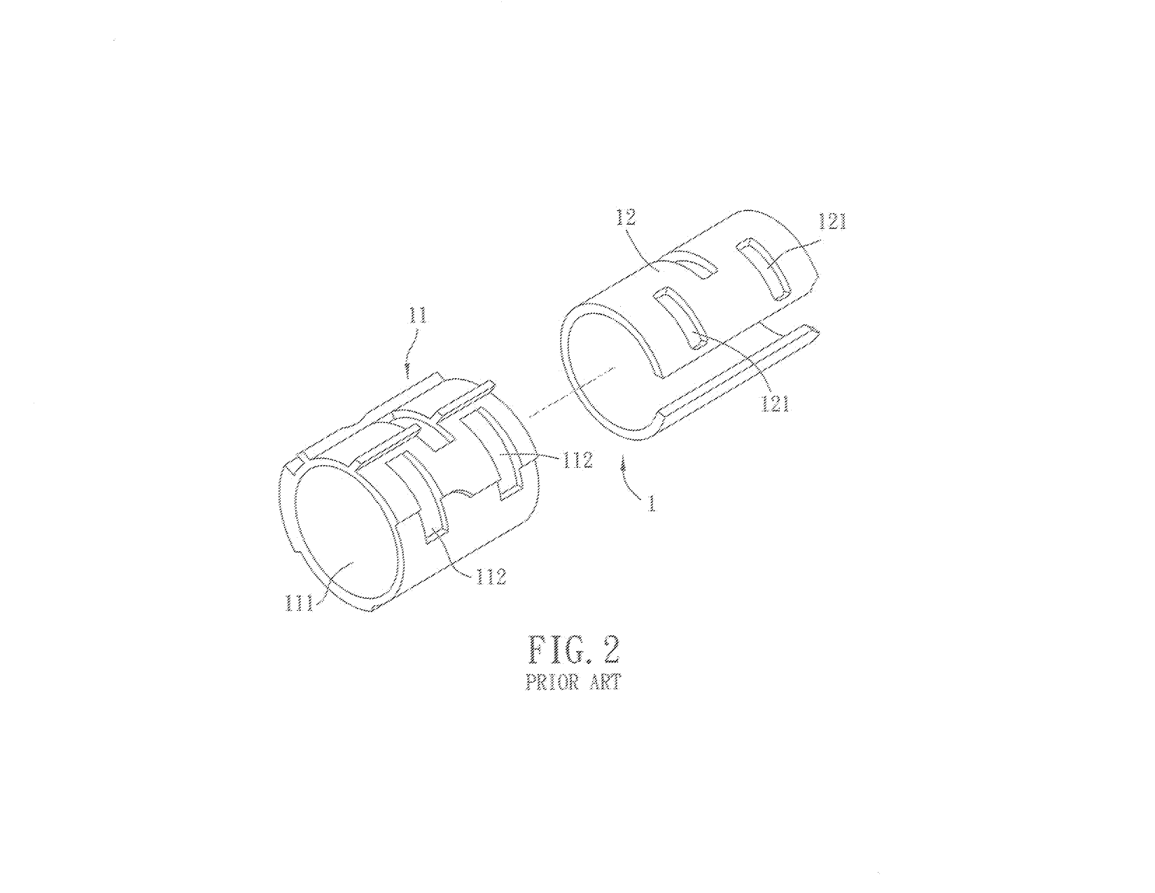

FIG. 3 is an exploded perspective view of a first preferred embodiment of a cylinder device according to the present invention;

FIG. 4 is a sectional view of the cylinder device of the first preferred embodiment in a pneumatic tool;

FIG. 5 is another sectional view of the cylinder device of the first preferred embodiment in the pneumatic tool;

FIG. 6 is a flow chart showing a manufacturing process of the cylinder device of the first preferred embodiment;

FIG. 7 is an exploded perspective view of a second preferred embodiment of a cylinder device according to the present invention;

FIG. 8 is a sectional view of the cylinder device of the second preferred embodiment in a pneumatic tool;

FIG. 9 is an exploded perspective view of a third preferred embodiment of a cylinder device of the present invention in a pneumatic tool; and

FIG. 10 is a sectional view of the cylinder device of the third preferred embodiment in a the pneumatic tool.

### DETAILED DESCRIPTION OF THE PREFERRED EMBODIMENTS

Before the present invention is described in greater detail, it should be noted that like elements are denoted by the same reference numerals throughout the disclosure.

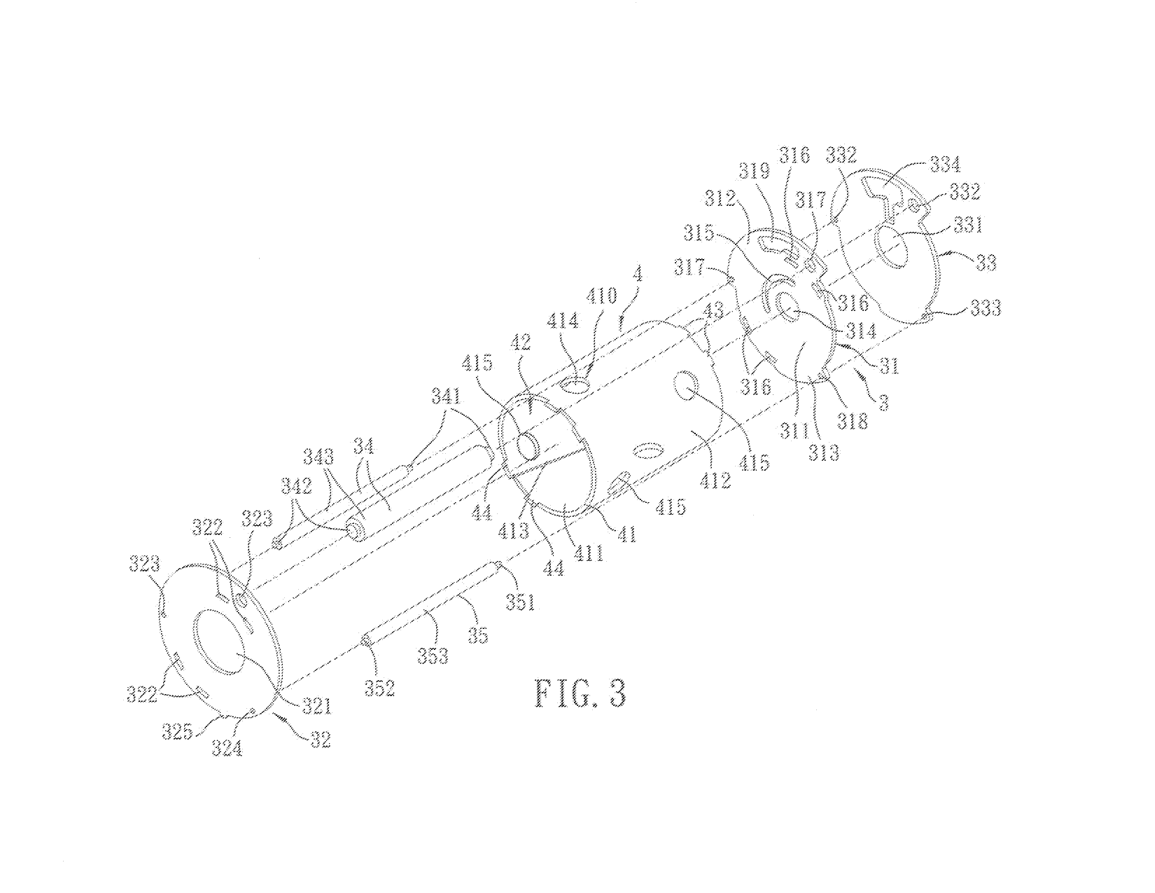

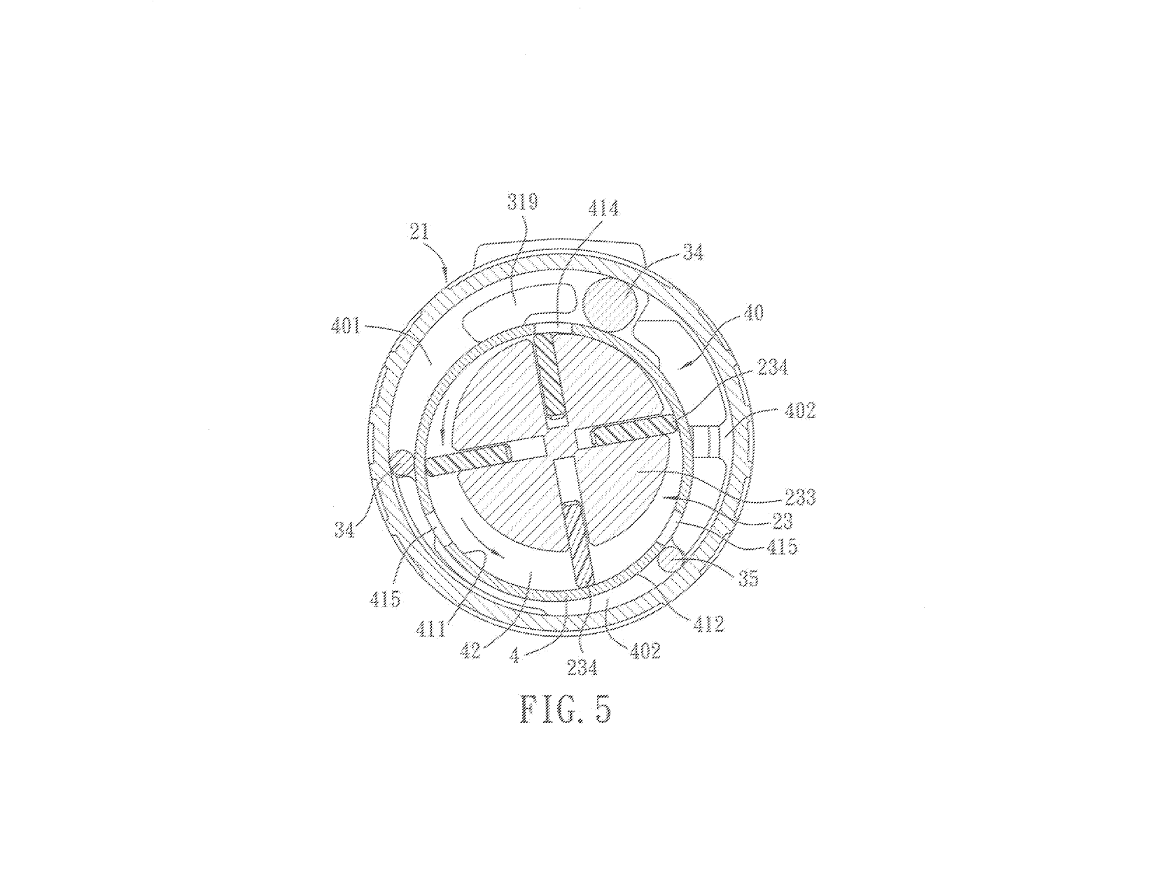

As shown in FIGS. 3, 4 and 5, a first preferred embodiment of a cylinder device 20 according to the present invention is adapted for use in a pneumatic tool 2. The pneumatic tool 2 includes a casing 21 that consists of a rear casing part 211 and a front casing part 212. The casing 21 has an inner surrounding surface 214 that defines a retaining space 213 for retaining the cylinder device 20, a positioning groove 215 that is formed in the inner surrounding surface 214, and an inlet channel 216 that communicates fluidly the retaining space 213 with external environment. The pneumatic tool 2 further includes a rotor 23, rear and front bearings 22, 22′, and a valve unit 24. The rotor 23 is disposed in the cylinder device 20, is rotatable about an axis (L), and has a rotor body 233, and rear and front axle portions 231, 232 extending respectively from rear and front ends of the rotor body 233 along the axis (L). The rear and front bearings 22, 22′ are sleeved respectively on the rear and front axle portions 231, 232. The rotor 23 further has a plurality of angularly spaced-apart vanes 234 (see FIG. 5) that are inserted movably into the rotor body 233. The valve unit 24 is operable to permit or block flow of air into the casing 21 via the inlet channel 216 through the valve unit 24.

The cylinder device 20 comprises a base frame unit 3 and a cylinder body 4. The base frame unit 3 includes first and second end components 31, 32, and an air-guiding plate 33.

In this embodiment, the first and second end components 31, 32 are disposed in the retaining space 213, are spaced apart from each other along the axis (L), and are configured as substantially round metal plates. The first end component 31 is disposed proximate to the rear bearing 22, and has a main portion 311 and substantially fan-shaped first and second extending portions 312, 313 that extend radially and outwardly from the main portion 311 and that are angularly spaced apart about the axis (L). The first end component 31 is formed with a first through hole 314 corresponding in position to the main portion 311 for extension of the rear axle portion 231 of the rotor 23 therethrough, and is further formed with a plurality of first engaging grooves 316 that are radially spaced apart from the first through hole 314. The first extending portion 312 is formed with two angularly spaced-apart first insertion holes 317. The second extending portion 313 is formed with a first auxiliary hole 318.

The second end component 32 is disposed proximate to the front bearing 22′, and is formed with a second through hole 321 at substantially center for extension of the front axle portion 232 of the rotor 23 therethrough, a plurality of second engaging grooves 322 that are radially spaced apart from the second through hole 321, two second insertion holes 323 that correspond respectively in position to the first insertion holes 317 in the direction of the axis (L), and a second auxiliary hole 324 that corresponds in position to the first auxiliary hole 318 in the direction of the axis (L). The second end component 32 has a positioning protrusion 325 for engaging the positioning groove 215 of the casing 21.

The air-guiding plate 33 is disposed between the first end component 31 and the rear bearing 22, is disposed to abut against a side surface of the first end component 31 opposite to the second end component 32 along the axis (L), and is formed with a third through hole 331 at substantially center for extension of the rear axle portion 231 of the rotor 23 therethrough, two third insertion holes 332 that are registered respectively with the first insertion holes 317 along the axis (L), and a third auxiliary hole 333 that is registered with the first auxiliary hole 318 along the axis (L).

The cylinder body 4 is made of metal, and has a surrounding wall 41 coupled between the first and second end components 31, 32, having the form of a tube, and defining an inner space part 42 for accommodating a portion of the rotor 23, and disposed eccentric with respect to the rotor 23. The surrounding wall 41 has an inner surrounding surface 411 defining the inner space part 42, and an outer surrounding surface 412 cooperating with the inner surrounding surface 214 of the casing 21 to define an annular space part 40 therebetween. The surrounding wall 41 further has a plurality of first engaging protrusions 43 for engaging respectively the first engaging grooves 316 of the first end component 31, a plurality of second engaging protrusions 44 for engaging respectively the second engaging grooves 322 of the second end component 32, and a slit 413 that communicates fluidly the inner space part 42 with the annular space part 40.

The base frame unit 3 further includes a pair of main dividing members 34 and an auxiliary dividing member 35. In this embodiment, the main and auxiliary dividing members 34, 35 are disposed in the annular space part 40, and are configured as rods interconnecting the first and second end components 31, 32. Each of the main dividing members 34 has: a first end section 341 inserted into a respective one of the first insertion holes 317 and a respective one of the third inserting holes 332; an second end section 342 opposite to the first end section 341 of the main dividing member 34 and inserted into a respective one of the second insertion holes 323; and a main section 343 interconnecting the first and end sections 341, 342. The auxiliary dividing member 35 has: a first end section 351 inserted into the first auxiliary hole 318 and the third auxiliary hole 333; and second end section 352 opposite to the first end section 351 and inserted into the second auxiliary hole 324; and a main section 353 interconnecting the first and second end sections 351, 352. The main dividing members 34 and the auxiliary dividing member 35 cooperate to divide the annular space part 40 into an intake space region 401 and two discharge space regions 402.

The intake space region 401 is defined by the main dividing members 34, and each of the discharge space regions 402 is defined by the auxiliary dividing member 35 and a respective one of the main dividing members 34. The surrounding wall 41 of the cylinder body 4 is formed with a ventilating unit 410 including an inlet hole 414 that communicates fluidly the intake space region 401 with the inner space part 42, and a plurality of outlet holes 415 that communicate fluidly and respectively the discharge space regions 402 with the inner space part 42. The first end component 31 is further formed with an inner guiding hole 315 in fluid communication with the inner space part 42, and a curved outer guiding hole 319 in fluid communication with the intake space region 401 of the annular space part 40. The air-guiding plate 33 is further formed with a communication hole 334 fluidly communicating the inlet channel 216 with the inner and outer guiding holes 315, 319 of the first end component 31.

When compressed air is introduced from the external environment into the inlet channel 216, a large portion of the compressed air enters the intake space region 401 of the annular space part 40 through the communication hole 334 of the air-guiding plate 33 and the outer guiding hole 319 of the first end component 31, and subsequently enters the inner space part 42 via the inlet hole 414, thereby driving rotation of the rotor 23. A remaining portion of the compressed air enters the inner space part 42 through the communication hole 334 of the air-guiding plate 33 and the inner guiding hole 315 of the first end component 31, thereby pushing the vanes 234 radially and outwardly against the inner surround surface 411 of the surrounding wall 41 of the cylinder body 4. The air after expansion is discharged into the external environment via the discharge space regions 402 of the annular space part 40 and the outlet holes 415.

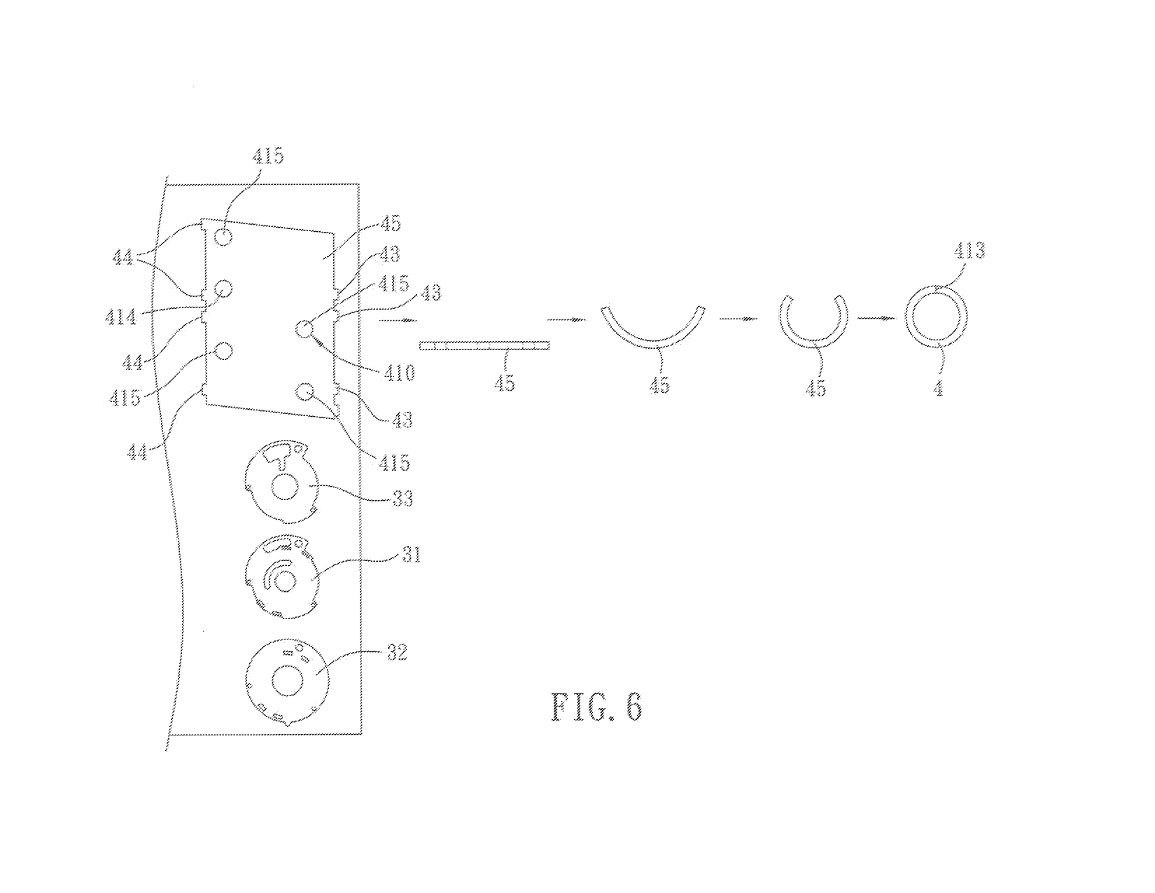

Referring to FIGS. 3 and 6, a method for manufacturing the cylinder device 20 according to the present invention comprises the following steps.

The first step includes providing a metal base sheet 45, which may be a zinc-coated steel sheet or any other steel sheet formed from a raw steel plate through cutting. The metal base sheet 45 has opposite edges formed integrally and respectively with the first and second engaging protrusions 43, 44. The ventilating unit 410, including the inlet hole 414 and the outlet holes 415, is then formed in the metal base sheet 45 through punching. The cutting and punching processes may be performed simultaneously. Subsequently, the metal base sheet 45 is bent to form the cylinder body 4.

The second step includes forming the first and second end components 31, 32 and the air-guiding plate 33 from the raw steel plate through cutting and punching. It is worth noting that the first and second steps may be performed simultaneously. In addition, the main and auxiliary dividing members 34, 35 are made from metal rods having different diameters.

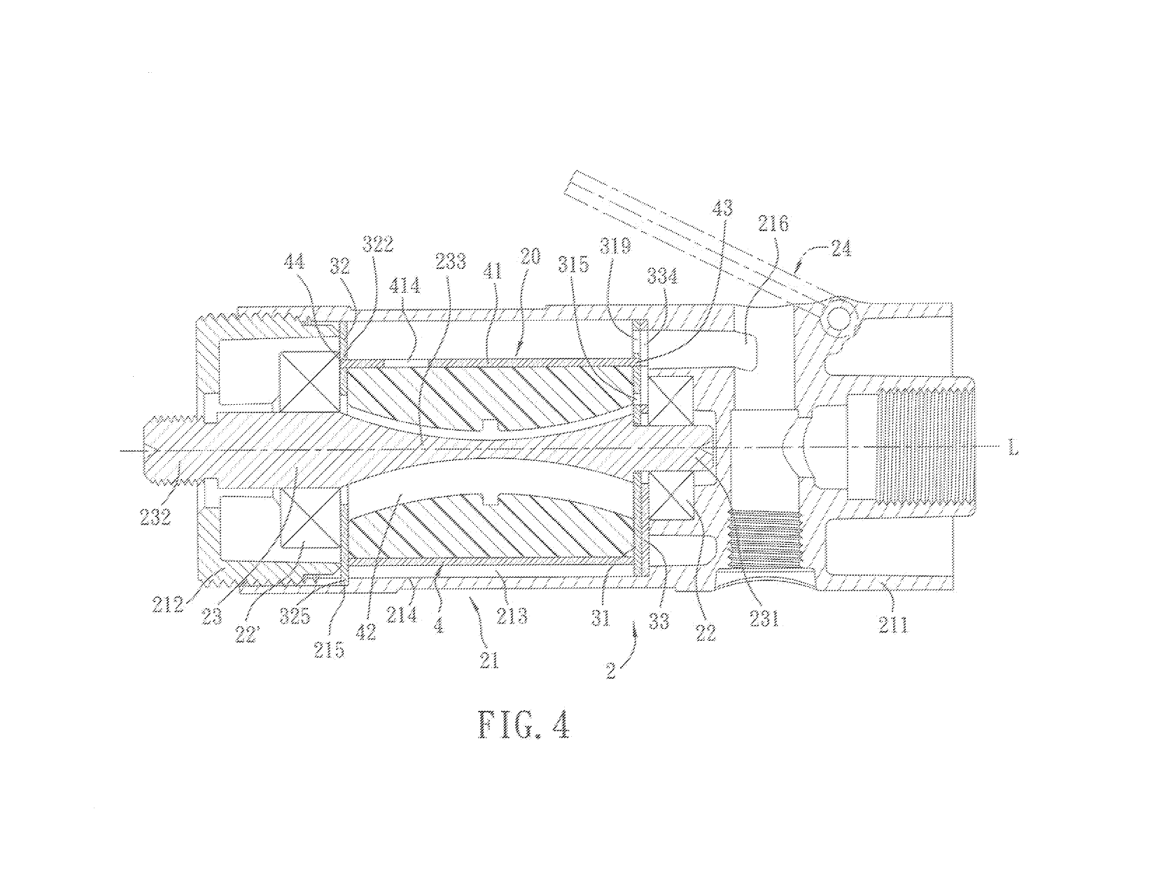

Referring further to FIGS. 4 and 5, the third step includes assembling the rotor 23 in the cylinder body 4, and to couple the cylinder body 4, and the main and auxiliary dividing members 34, 35 between the second end component 32 and the combination of the first end component 31 and the air-guiding plate 33. The engagement among the cylinder body 4 and the first and second end components 31, 32 also enhances the structural strength of the cylinder body 4. After assembling, the cylinder device 20 is disposed into the casing 21 of the pneumatic tool 2 with the projecting portion 325 engaged with the positioning groove 215 of the casing 21.

To summarize, the cylinder device 20 of this invention has a novel structure and a simple and time-saving manufacturing process, since most components of the cylinder device 2 can be made by cutting, punching and bending.

Moreover, since the first and second end components 31, 32, the air-guiding plate 33, and the cylinder body 4 may be made from metal sheets, it is relatively easy to choose corrosion-resistant and durable steel plates or zinc-coated steel plates for making these components. Furthermore, the inner surround surface 411 of the surrounding wall 41 of the cylinder body 4 is relatively smooth, which ensures smooth operation of the rotor 23.

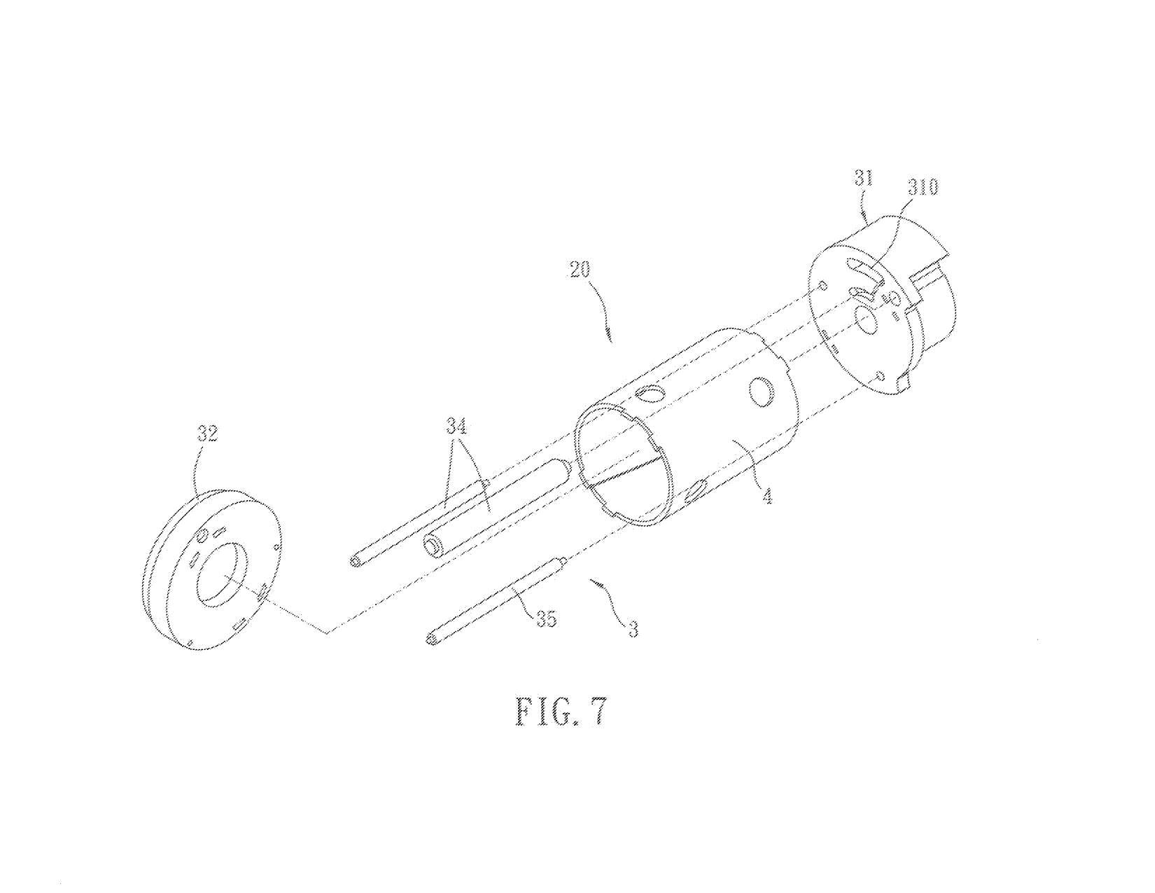

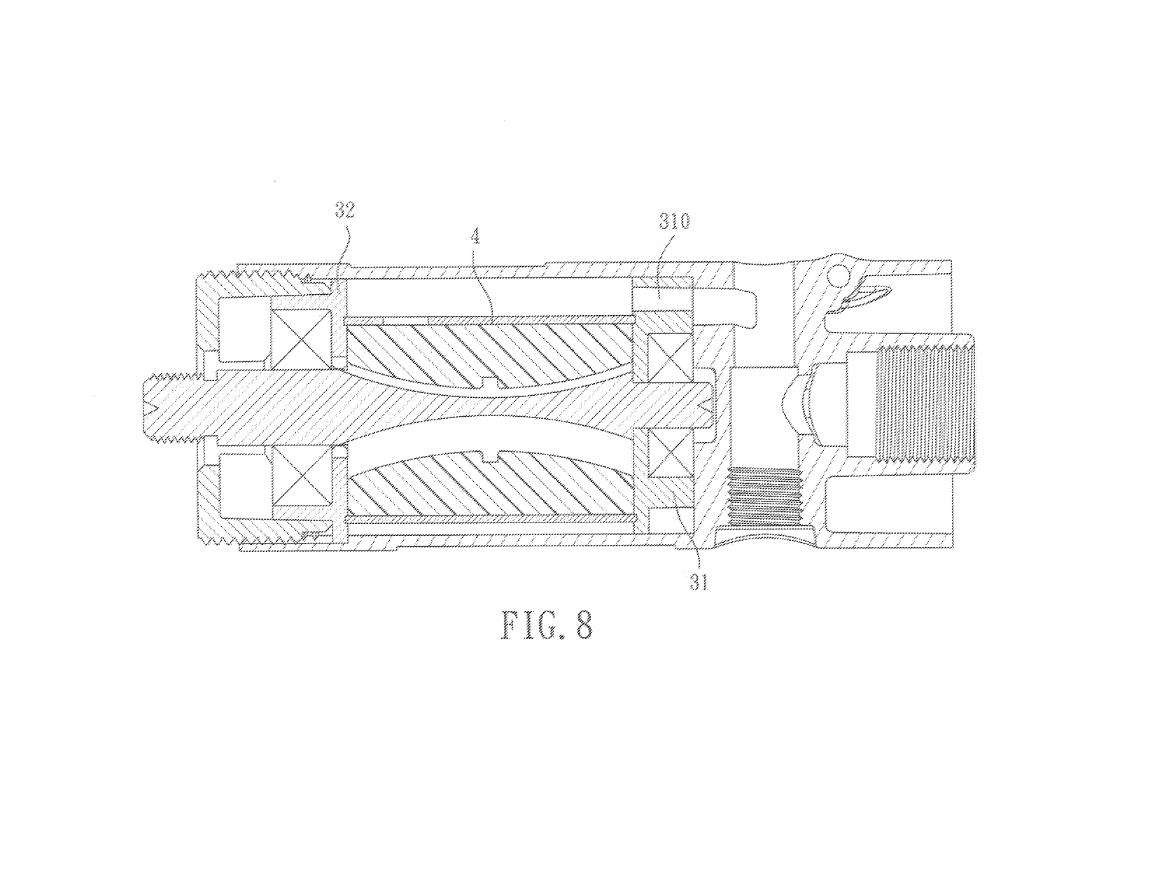

Referring to FIGS. 7 and 8, the second preferred embodiment of the cylinder device 20 according to this invention has a structure similar to that of the first preferred embodiment. The main difference between the first and second preferred embodiments resides in that, in the second preferred embodiment, the air-guiding plate 33 is omitted. The first end component 31 in this embodiment is configured as a round hollow block formed with an air-guiding hole 310 in place of the inner and outer guiding hole 315, 319 and the communication hole 334 of the first preferred embodiment. The second end component 32 of this embodiment is also configured as a round hollow block.

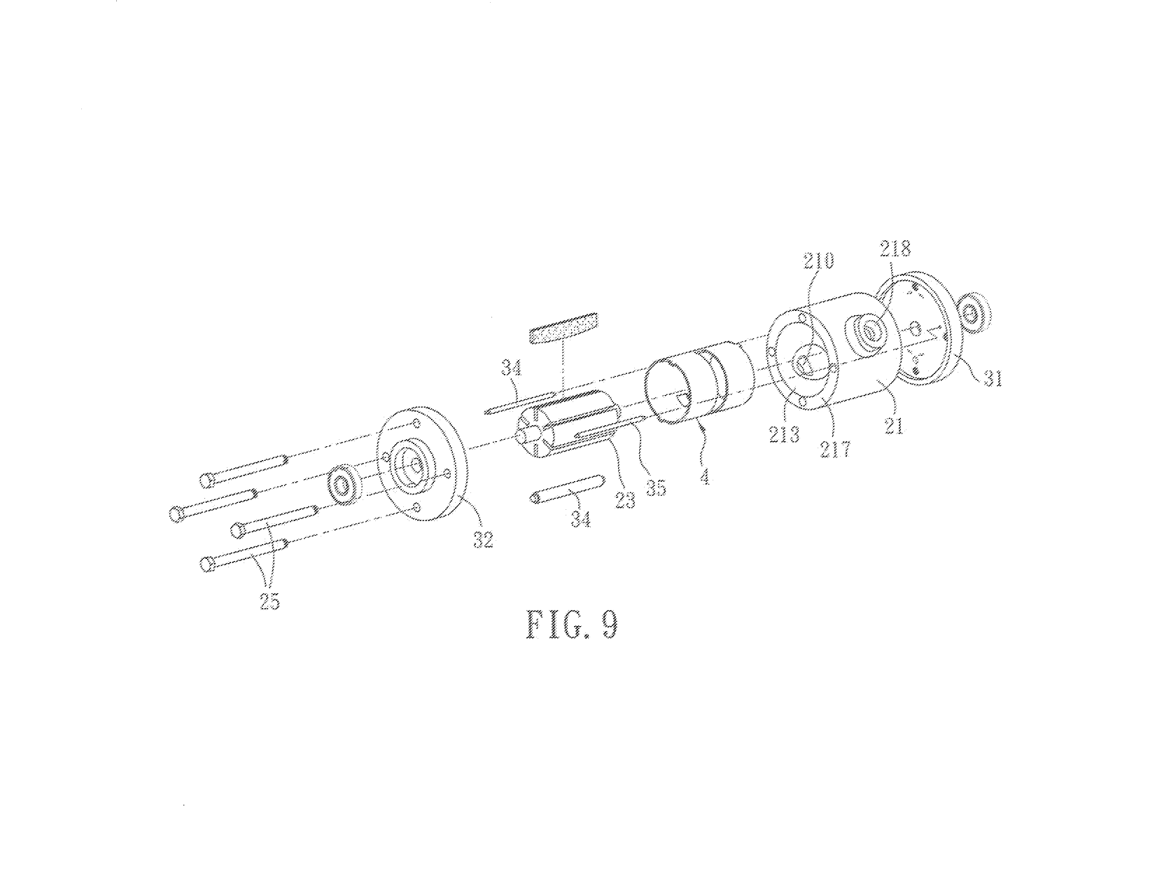

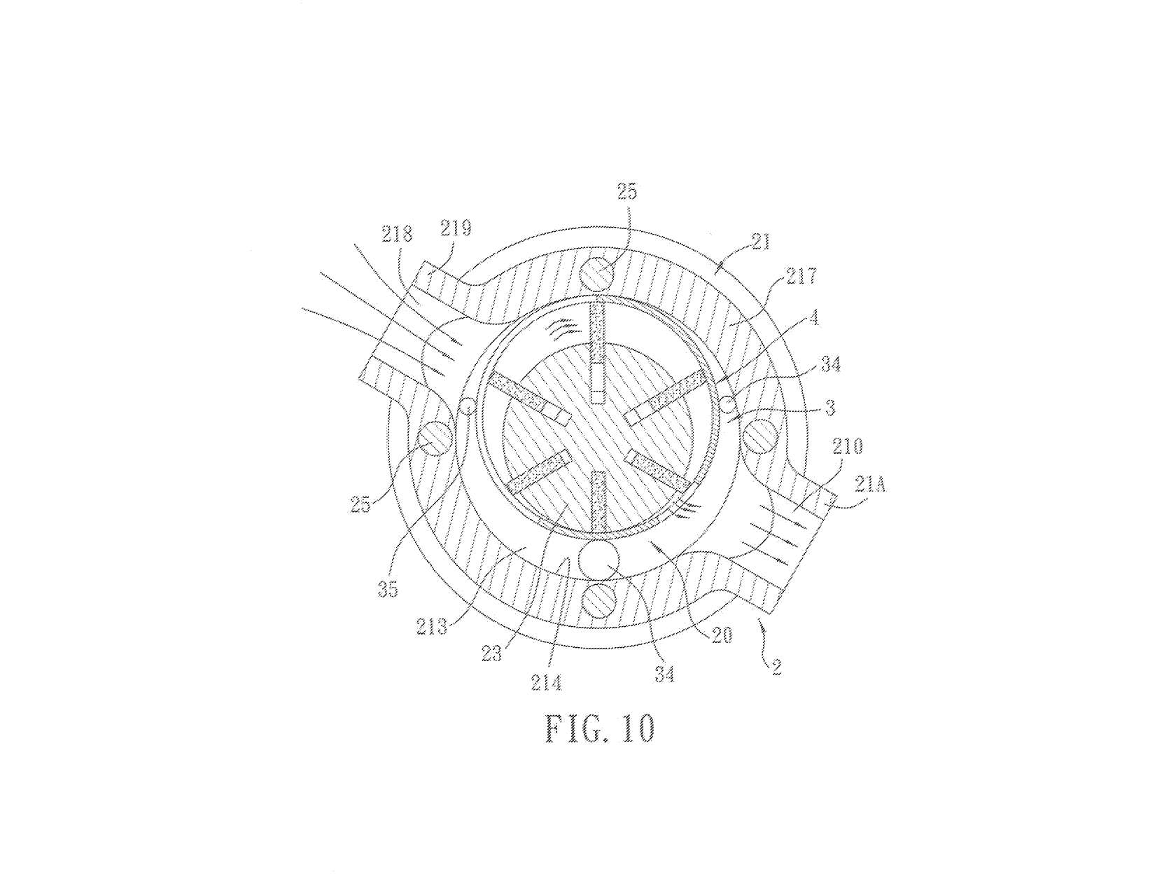

Referring to FIGS. 9 and 10, the third preferred embodiment of the cylinder device 20 according to the present invention is adapted for use in an air compressor 2 and has a structure similar to that of the second preferred embodiment. The main difference between this embodiment and the second preferred embodiment resides in that, in the third preferred embodiment, the compressor 2 includes a casing 21 having an outer surrounding wall 217 that has an inner surrounding surface 214 defining a retaining space 213, an inlet wall segment 219 that defines an inlet channel 218 in fluid communication with the retaining space 213, and an outlet wall segment 21A that defines an outlet channel 210 in fluid communication with the retaining space 213.

The cylinder device 20 comprises a base frame unit 3 including first and second end components 31, 32 that are coupled to opposite ends of the outer surrounding wall 217 along an axis, and a cylinder body 4 that is disposed in the base frame unit 3 and is coupled between the first and second end components 31, 32. The base frame unit 3 further includes a pair of main dividing members 34 and an auxiliary dividing member 35 for dividing a space between the outer surrounding wall 217 and the cylinder body 4 into two intake regions and a discharge region. The air compressor 2 further includes a plurality of fixing members 25 extending threadedly through the first and second end components 31, 32 and the outer surrounding wall 217 for securing the first and second end components 31, 32 onto the outer surrounding wall 217.

In use, air introduced from the external environment enters the cylinder body 4 via the inlet channel 218 to be pressurized through the rotation of a rotor 23, and is expelled to the external environment via the outlet channel 210.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A cylinder device adapted for use in a pneumatic tool, the pneumatic tool including a casing that has in inner surrounding surface defining a retaining space for retaining said cylinder device, and a rotor that is disposed in said cylinder device and that is rotatable about an axis, said cylinder device comprising:
a base frame unit including first and second end components that are disposed in the retaining space and that are spaced apart from each other along the axis; and
a cylinder body having a surrounding wall that is coupled between said first and second end components, that is eccentric with respect to the rotor, that defines an inner space part for retaining the rotor, and that cooperates with the inner surrounding surface of the casing to define an annular space part therebetween, said base frame unit further including a pair of main dividing members that are coupled between said first and second end components, and that are disposed in said annular space part for dividing said annular space part into an intake space region and at least one discharge space region, said surrounding wall having an inlet hole that communicates fluidly said intake space region with said inner space part, and a plurality of outlet holes that communicate fluidly said at least one discharge space region with said inner space part;
wherein compressed air introduced from the external environment into said intake space region of said annular space part enters said inner space part via said inlet hole to drive rotation of the rotor, and is advanced into said discharge space region of said annular space part via said outlet holes to be expelled to the external environment.

2. The cylinder device as claimed in claim 1, wherein said base frame unit further includes an auxiliary dividing member coupled between said first and second end components, and cooperating with said main dividing members to define two of said discharge space regions, each being formed between said auxiliary dividing member and a respective one of said main dividing members.

3. The cylinder device as claimed in claim 1, wherein:
said first end component is formed with a first through hole adapted for extension of the rotor therethrough, and a plurality of first engaging grooves that are radially spaced apart from said first through hole;
said second end component is formed with a second through hole adapted for extension of the rotor therethrough, and a plurality of second engaging grooves that are radially spaced apart from said second through hole; and
said surrounding wall of said cylinder body further has a plurality of first engaging protrusions that engage respectively said first engaging grooves of said first end component, and a plurality of second engaging protrusions that engage respectively said second engaging grooves of said second end component.

4. The cylinder device as claimed in claim 3, wherein:
said first end component is further formed with two spaced-apart first insertion holes corresponding in position to said annular space part;
said second end component is further formed with two second insertion holes aligned respectively to said first insertion holes in the direction of the axis; and
each of said main dividing members has a first end inserted into a respective one of said first inserting holes and an opposite second end inserted into an aligned one of said second insertion holes.

5. The cylinder device as claimed in claim 4, wherein:
said first end component is further formed with a first auxiliary hole corresponding in position to said annular space part;
said second end component is further formed with a second auxiliary hole aligned with said first auxiliary hole in the direction of the axis; and
said base frame unit further includes an auxiliary dividing member having opposite ends that are inserted respectively into said first and second auxiliary holes, and that cooperates with said main dividing members to define two of said discharge space regions, each being formed between said auxiliary dividing member and a respective one of said main dividing members.

6. The cylinder device as claimed in claim 4, wherein:
said first end component is further formed with an inner guiding hole in fluid communication with said inner space part, and an outer guiding hole in fluid communication with said annular space part; and
said base frame unit further includes an air guide plate that clings to a side surface of said first end component opposite to said second end component along the axis, and that is formed with
a communication hole in fluid communication with said inner and outer guiding holes of said first end component, and
two third insertion holes engaged respectively with said first ends of said main dividing members.

7. A method for making a cylinder device as claimed in claim 1, comprising the steps of:
(A) preparing a metal base sheet, punching the inlet hole and the outlet holes in the metal base sheet, and bending the metal base sheet to form the cylinder body;
(B) preparing the first end component, the second end component and the main dividing members; and
(C) coupling the first and second end components to opposite ends of said cylinder body, and coupling the main dividing members between the first and second end components.

8. The manufacturing process as claimed in claim 7, wherein, in step (B), the first and second end components are metal plates made by cutting and punching.

9. A cylinder device of a pneumatic tool, the pneumatic tool including an outer surrounding wall that has an inner surrounding surface defining a retaining space, and a rotor that is rotatable about an axis, said cylinder device comprising:
a base frame unit including first and second end components that are coupled to opposite ends of the outer surrounding wall along the axis; and
a cylinder body having a surrounding wall that is coupled between said first and second end components in the retaining space, that is eccentric with respect to the rotor, that defines an inner space part for retaining the rotor, and that cooperates with the inner surrounding surface of the outer surrounding wall to define an annular space part therebetween, said base frame unit further including a pair of main dividing members that are coupled between said first and second end components, that are disposed in said annular space part for dividing said annular space part into an intake space region and at least one discharge space region, said surrounding wall having an inlet hole that communicates fluidly said intake space region with said inner space part, and a plurality of outlet holes that communicates fluidly said at least one discharge space region with said inner space part;
wherein air introduced from the external environment into said intake space region of said annular space part enters said inner space part via said inlet hole to be pressurized through the rotation of the rotor, and is advanced into said discharge space region of said annular space part via said outlet holes to be expelled to the external environment.
